(19) United States
(12) Patent Application Publication
(10) Pub. No.: US 2026/0124681 A1
(43) Pub. Date: May 7, 2026

(54) QUALITY ASSURANCE OF AN ADDITIVELY MANUFACTURED PART

(71) Applicant: Raytheon Company, Tewksbury, MA (US)

(72) Inventors: Matthew E. Lynch, Canton, CT (US); Jeffrey A. Shubrooks, South Boston, MA (US); Travis L. Mayberry, Dallas, TX (US); Stuart Taylor, Allen, TX (US)

(21) Appl. No.: 18/937,901

(22) Filed: Nov. 5, 2024

(51) Int. Cl. B22F 10/85; B22F 12/90; B33Y 50/02

(52) U.S. Cl. CPC B22F 10/85; B22F 12/90; B33Y 50/02

(57) ABSTRACT

Devices, systems, machine-readable media, and methods for quality assurance of an additively manufactured part are provided. A method includes receiving by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process; identifying, based on the proprietary additive manufacturing process parameter, the non-proprietary additive manufacturing process parameter, and the sensor data, a defect of the additively manufactured part; filtering out the proprietary additive manufacturing process parameter, resulting in filtered information; generating, based on the filtered information, a quality assurance report of the additively manufactured part; providing the quality assurance report to a customer, the quality assurance report includes a description of the defect and location of the defect; and delivering, based on the defect passing a part acceptance criterion, the additively manufactured part.

### TECHNICAL FIELD

Embodiments discussed herein regard devices, systems, machine-readable media, and methods in the field of additive manufacturing. Embodiments regard quality assurance and quality control of additively manufactured parts. Embodiments identify the presence of defects in additively manufactured parts and evaluate these defects for part acceptance without divulging proprietary manufacturing or analysis processes.

### BACKGROUND

Additive manufacturing is a manufacturing process that builds parts sequentially, layer by layer. This approach stands in contrast to subtractive manufacturing methods, in which parts are shaped by removing material from a larger block or piece.

One advantage of additive manufacturing is it enables the production of intricate and complex parts that would be difficult or prohibitively expensive to create through subtractive manufacturing techniques. Additive manufacturing provides new possibilities for design and engineering options across various industries.

One of the key advantages of additive manufacturing is its ability to significantly accelerate the product development cycle. Additive manufacturing allows for quick iteration and testing of parts. Additive manufacturing can reduce the time and cost associated with product development and refinement. Additive manufacturing is also particularly suited for high value, low volume components due to its efficiency and low minimum order quantity.

### BRIEF DESCRIPTION OF THE DRAWINGS

FIG. 1 illustrates, by way of example, a diagram of a quality assurance system of an additively manufactured part.

FIG. 2A illustrates, by way of example, a diagram of an embodiment of defect identification by an acoustic signal of the quality assurance system of FIG. 1.

FIG. 2B illustrates, by way of example, a diagram of an embodiment of defect identification by a temperature map of the quality assurance system of FIG. 1.

FIG. 2C illustrates, by way of example, a diagram of an embodiment of defect identification by a visual identification method of the quality assurance system of FIG. 1.

FIG. 2D illustrates, by way of example, a diagram of an embodiment of determination of as-built contour by tracking melt pool geometry around the exterior of a specified geometry, with comparison to the nominal geometry, of the quality assurance system process of FIG. 1

FIG. 3 illustrates, by way of example, a diagram of an embodiment of defect identification by stacking multiple 2D images into a 3D reconstruction, of the quality assurance system of FIG. 1.

FIG. 4A-4D illustrate, by way of examples, embodiments of a quality assurance report.

FIG. 5 illustrates by way of example, a flow diagram of an embodiment of a method for defect detection by a quality assurance system.

FIG. 6 illustrates, by way of example, a machine learning (ML) engine for training a ML model.

FIG. 7 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Complex assemblies and builds often involve components from multiple part suppliers. Each supplier contributes individualized and specialized parts to the final product. For additively manufactured parts, each supplier can possess proprietary process information of how they produce these parts, which they prefer to keep confidential. The proprietary process can form part of their manufacturing capabilities that can contribute to their market positions. In some instances, proprietary process information can be designated as confidential, trade secrets, or the like. Manufacturers keep proprietary process information confidential to protect their competitive edge in the market.

However, the quality of an individual additively manufactured part is of importance to the customers who rely on these parts in their builds. Additive manufacturing represents a shift from conventional manufacturing systems in terms of part consistency. While manufacturing processes like injection molding produce nearly identical parts due to their repetitive nature, additive manufacturing processes create each part individually. The difference can lead to part-to-part variations if process variables are not tightly controlled. The additively manufactured part can serve as a key or critical component in an application, making the structural integrity, absence of defects in the part, or types of defects in the part important considerations for customers. Therefore, implementing a method or system to evaluate each additively manufactured part after production (e.g., and before delivery of the part) can be valuable to a manufacturer, customer, or both. Such an approach can provide quality assurance consistency between parts or provide customers with confidence when accepting parts produced through an additive manufacturing process.

Typically, the presence of defects in an additively manufactured part can be discerned through monitoring of in-process build parameters. These parameters, which may include laser power, scan speed, or layer thickness, are often considered proprietary process information by the manufacturer. Manufacturers can desire to keep such a proprietary process condition confidential to preserve their intellectual property as trade secrets and maintain an advantage over their competitors.

The systems and methods described herein addresses the technical problem of safeguarding a manufacturer's proprietary process information while simultaneously providing sufficient information to customers about the quality and associated defect(s) of an additively manufactured part. This approach strikes a balance between protecting valuable trade secrets and ensuring transparency in part quality. This can be achieved by using a proprietary process condition and optional sensor data within the manufacturer's closed environment to produce a quality assurance report. The quality assurance report can include an identified defect, a part acceptance recommendation, or a combination thereof, without divulging any confidential proprietary process conditions.

By implementing these systems and methods described herein, customers can gain confidence in the received parts for their end applications. This customer confidence can be important, particularly in industries where part failure can have severe consequences, such as the aerospace, automotive, or medical device industry.

As used herein, the term “additively manufactured part” can be used interchangeably with “additive manufactured part,” “additively manufactured component,” or “additive manufactured component”. As used herein, the term “customer's build” can be used interchangeably with “build,” or “assembled build”.

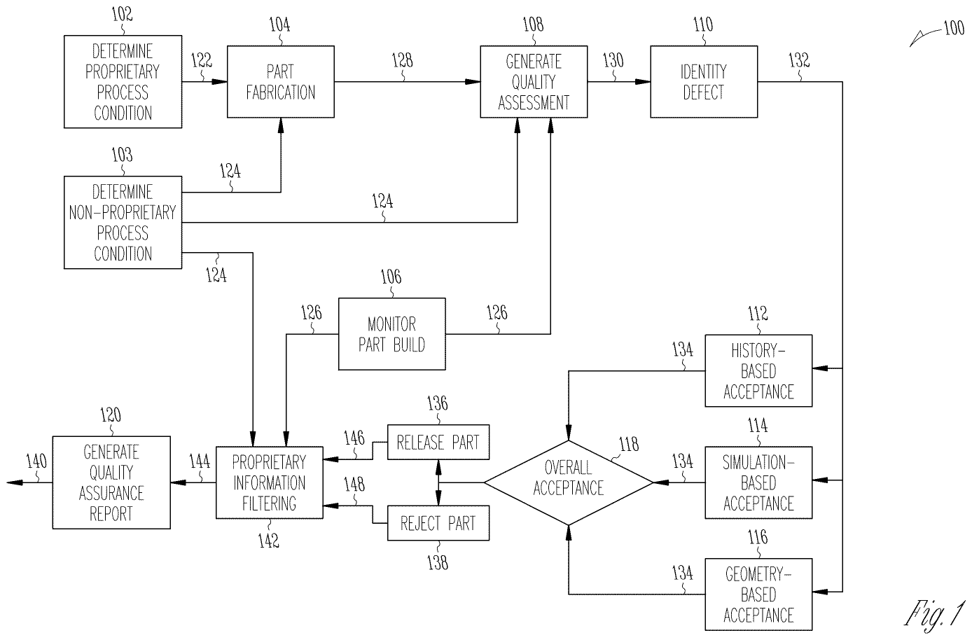

FIG. 1 illustrates, by way of example, a flow diagram of a quality assurance system process 100 of an additively manufactured part. The additive manufacturing process described herein can include, for example, powder bed fusion, selective laser melting, electron beam melting, directed metal laser sintering, directed energy deposition, laser engineered net shaping, electron beam freeform fabrication, wire-arc additive manufacturing, wire-laser additive manufacturing, binder jetting, material extrusion, fused filament fabrication, friction stir additive manufacturing, friction deposition, sheet lamination, or ultrasonic additive manufacturing. In some examples, the quality assurance system process 100 can also be applied to heat treatment processes related to additive manufacturing.

The quality assurance system process 100 as illustrated, can determine a proprietary process parameter 102. A proprietary process parameter 122 can be a process condition of the additive manufacturing process that the manufacturer would like to keep secret and confidential, without revealing the proprietary process parameter 122 to personnel outside a company. A proprietary process parameter 122 can include, for example, a scan vector parameter, a layer thickness, an energy source parameter, a powder bed parameter, a heat treatment parameter, or a post-processing parameter. As used herein, the term “process condition” can be used interchangeably with “process parameter,” “parameter,” or “processing parameter”.

Examples of a scan vector parameter can include a scan pattern, a scan speed, a hatch spacing, a scan angle, a layer rotation, an infill strategy, a scan overlap amount, a beam focus setting, or a scan order. Examples of an energy source parameter can include a power output, a laser power, a laser speed, a pulse duration, a pulse frequency, a spot size, an energy density, a beam profile, a wavelength, a beam divergence, a modulation setting, a laser position, or a beam polarization. Examples of a powder bed parameter can include a layer thickness, a powder particle size distribution, a powder bed temperature, a powder spreading mechanism, a powder bed density, a powder flowability index, a powder composition, a powder recycling ratio, or a powder bed preheating profile. Examples of a heat treatment parameter can include an aging temperature, an aging duration, a heating rate, a cooling rate, a stress relief temperature, or a stress relief duration. When a solution is used in heat treatment, a heat treatment parameter can include a solution treatment temperature, a solution treatment duration, or a quenching method.

The quality assurance system process 100 can also determine a non-proprietary process parameter 103. The non-proprietary process parameter 124 can refer to a process condition that is generic in nature or does not disclose proprietary information to outside entities. The non-proprietary process parameter 124 can be important in determining one or more attributes of the additively manufactured part. Examples of the non-proprietary process parameter 124 can include a chamber oxygen concentration, a heat treatment profile, a build plate temperature, a process chamber temperature, a turbine pressure, or a turbine pressure ramp rate. In some examples, a processing parameter can be a proprietary process parameter 122, or a non-proprietary process parameter 124. The determination of what constitutes a proprietary process parameter 122 can vary from manufacturer to manufacturer, part to part, or process to process.

In some examples, the quality assurance system process 100 can receive the non-proprietary process parameter 124, the proprietary process parameter 122, or a combination thereof for use in part fabrication 104. In operation 104, the additive manufacturing process can produce an additively manufactured part. The additive manufacturing process can also produce in-process fabrication data 128. In some examples, the in-process fabrication data 128 can include a process tag from the manufacturing process that tracks an in-line process parameter. The process tag can be compared against a setpoint of the proprietary process parameter 122 or non-proprietary process parameter 124. The in-process fabrication data 128 can also include a deviation between the setpoint and recorded process parameter. In some examples, the in-process fabrication data 128 can be collected over specific time periods, presented as overall time-averaged values, or recorded continuously.

In some examples, the quality assurance system process 100 can receive information from a sensor during the monitor part build 106 operation. In operation 106, a sensor can be used to track the progress of the part fabrication 104 operation. The sensor can track a build condition of the additively manufactured part as the additively manufactured part is being manufactured. The build condition can be an attribute of the part during the additive manufactured process. For example, the attribute of the additively manufactured part can include an acoustic response, a temperature map, a spatter pattern, an edge contour, or the like. The sensor-based monitoring can allow for real-time data collection and analysis during the additive manufacturing process. The sensor-based monitoring can also complement the tracking of a non-proprietary process parameter 124 and a proprietary process parameter 122 to enable quality controls and process optimization.

In some examples, the sensor can be an externally mounted sensor or an integrally mounted sensor to monitor part fabrication 106. An externally mounted sensor can be positioned around the build chamber, while an integrally mounted sensor can be incorporated into the additive manufacturing machine, such as, in the power source circuitry. In some examples, the sensor can track a proprietary process parameter 122, a non-proprietary process parameter 124, or collect sensor data 126 about a build condition parameter of the manufacturing process. In some examples, a variety of sensors can be used in the quality assurance system process 100. In some examples, the sensor can include a photodiode to detect change in light intensity, which can be used for monitoring laser power or melt pool dynamics. In some examples, the sensor can include an acoustic sensor to capture sound waves during the build process that can be indicative of anomalies and defects as they occur. In some examples, the sensor can include a transducer array to generate and receive ultrasonic waves that can allow for in-situ, real-time non-destructive testing of part integrity during the build. In some examples, the sensor can include a near-infrared (IR) wavelength camera to capture thermal information of the build, such as, monitoring melt pool behavior and temperature distribution. In some examples, the sensor can include a visible wavelength camera that can provide high-resolution imaging of the build process, potentially detecting issues with powder spreading, part geometry errors, spatter, or other obvious build defects. In some examples, the sensor can include a long-wave IR wavelength camera that can provide detailed thermal mapping of the entire build area. The thermal map can be useful for monitoring overall temperature distribution and identifying potential hot spots or cool zones. As used herein, the term “sensor data” can be used interchangeably with “sensor information”, or “intermediate data”.

In some examples, the quality assurance system process 100 can include a generate quality assessment 108 operation. The generate quality assessment 108 operation can receive as input, a proprietary process parameter 122, a non-proprietary process parameter 124, sensor data 126, or a combination thereof. The generate quality assessment 108 operation can consolidate one or more of the several types of data into a quality assessment data bundle 130 for input into an identify defect 110 operation. In the identify defect 110 operation, the quality assurance system process 100 can use one or more methods to identify defects, such as, numerical analysis, machine learning trained models, physics-based modelling, or a combination thereof. In some examples, the one or more methods to identify defects can be provided by the customer to the manufacturer. In some examples, an identified defect can be a geometric infidelity defect, porosity, cracking, a surface defect, a residual stress concentration, a microstructural defect, balling phenomena, keyhole porosity, lack of fusion, compositional inhomogeneity, an inclusion defect, boiling spatter, a flawed powder spreading, a gas flow irregularity, a temperature induced defect, a spatter induced defect, a swelling defect, a delamination defect, an anisotropic defect, or a combination thereof.

In some examples, numerical analysis deployed in the identify defect 110 operation can include an image processing algorithm for edge detection, and thresholding of the additively manufactured part. Numerical analysis can also include morphological operations used to identify anomalies in layer geometry or temperature distribution. In some examples, numerical analysis can include Fourier analysis applied to acoustic sensor data to detect frequency patterns associated with defects or process instabilities.

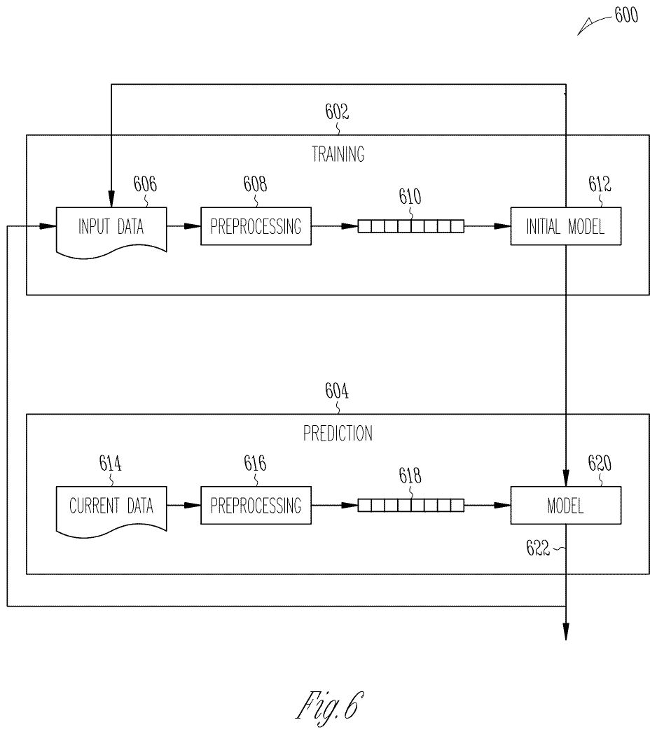

In some examples, machine learning trained models deployed in the identify defect 110 operation can include supervised or unsupervised learning algorithms. In some examples the machine learning trained model can include a computer vision system or a temperature system to predict metal grain and metal microstructure. Details of machine learning trained models are provided further in the discussion of FIG. 6.

In some examples, a physics-based model deployed in the identify defect 110 operation can include a finite element analysis (FEA) model, a computational fluid dynamics (CFD) model, fatigue analysis, thermal analysis, structural analysis, or a combination thereof. An example of a physics-based modeling software is the ANSYS family of products from ANSYS Inc. (Canonsburg, PA). In some examples, an FEA model can simulate the thermal and mechanical behavior of a part during the build process given input from sensors. For example, using temperature data from an IR camera, a FEA model can predict thermal stress distributions and a potential area of warping or residual stress. The prediction can help identify a region prone to cracking or deformation due to rapid heating and cooling cycles. In some examples, the physics-based model can be provided by the customer to the manufacturer.

In some examples, a CFD model can simulate the melt pool dynamics or powder particle behavior. For example, using data from a camera, a CFD model can predict spatter formation and keyhole porosity, indicative of a lack of fusion or a gas entrapment defect.

In some examples, a fatigue analysis model can predict part performance under cyclic loading conditions. For example, using sensor data 126, the fatigue analysis model can identify a potential weak point or an area prone to crack initiation. The identification can lead to detecting a defect that may not be immediately visible or apparent.

In some examples, a thermal analysis model can simulate heat transfer and temperature evolution during the part fabrication 104 operation. For example, using data from a thermal camera, thermal analysis can predict a cooling rate and a phase transformation. The prediction can identify an area prone to microstructural defects or undesired phase formation.

In some examples, a structural model can predict a deformation and a stress distribution under a loading condition. For example, sensor data 126 can identify an area of high stress concentration or an insufficient number of support structures. The identification can detect a potential area of part failure or dimensional inaccuracy.

In some examples, when the quality assurance system process 100 identifies a defect, a defect data bundle 132 with the identified defect can be input into a process history based acceptance 112, a simulation based acceptance 114, a geometry based acceptance 116, or a combination thereof. The defect data bundle 132 can include an identified defect, a quality assessment data bundle 130, a in-process fabrication data 128, a proprietary process condition 122, a non-proprietary process condition 124, sensor data 126, or a combination thereof. In some examples, the process history based acceptance 112, simulation based acceptance 114, or geometry based acceptance 116 can have a respective part acceptance criterion. In some examples, the process history based acceptance 112, the simulation based acceptance 114, or the geometry based acceptance 116 can be provided by the customer to the manufacturer. In some examples, the customer can provide the acceptance method, acceptance analysis, acceptance criterion, or a combination thereof.

In some examples, the process history based acceptance 112 operation can involve analysis of a proprietary process parameter 122, or a non-proprietary process parameter 124 to determine if the measured process condition falls within an operating specification. If the proprietary process parameter 122 or non-proprietary process parameter 124 falls within the defined specification, the part can be accepted. In some examples, a process history acceptance criterion can include a maximum or minimum setpoint for the proprietary process parameter 122 or non-proprietary process parameter 124. In some examples, the process history acceptance criterion can be provided by the customer to the manufacturer.

In some examples, the process history based acceptance 112 operation can involve comparing the defect data bundle 132 with previous occurrences of similar defects. The comparison can include comparing the type of identified defect or the number of identified defects with a historical record of the production of the part. The process history based acceptance 112 can assess whether the previous defect had a material impact on the performance of the additively manufactured part in an assembled build. By leveraging historical data, a customer can make an informed decision about whether to accept or reject an additively manufactured part with an identified defect based on past experiences and outcomes. In some examples, a process history acceptance criterion can include a maximum size of the defect based on historical records of past defects.

In some examples, the simulation based acceptance 114 operation can incorporate data from the defect data bundle 132 into a simulation based model to determine the functional acceptance of the additively manufactured part in the assembled build. The simulation based acceptance 114 can utilize a virtual or digital model of the additively manufactured part. The virtual or digital model can be derived from sensor data 126 and can include the identified defect. The virtual or digital model of the additively manufactured part can then be incorporated into a consolidated assembled build model. The consolidated assembled build model can be analyzed using one or more of the physics-based models described earlier (e.g., FEA, CFD, or fatigue analysis). The simulation based acceptance 114 can evaluate whether the consolidated assembled build with the additively manufactured part can meet a quality release requirement without failure during end-use or at the final application. The simulation based acceptance 114 operation can allow for a predictive assessment of the additively manufactured part's performance, considering the specific defect and its potential impact on the entire assembly. In some examples, a simulation analysis acceptance criterion can include the maximum or minimum extension or compression the additively manufactured part is allowed to deform when a load is applied. In some examples, the simulation analysis acceptance criterion can be provided by the customer to the manufacturer.

In some examples, the geometry based acceptance 116 operation can involve comparing the additively manufactured part's geometry with a specified or input geometry. The geometry based acceptance 116 can determine if any deviation from the input geometry can result in part failure. The geometry based acceptance 116 can include evaluating dimensional accuracy, surface finish, overall shape conformity, or a combination thereof. A manufacturer or a customer can determine whether the additively manufactured part can meet the required specifications and tolerances for part release. The determination can be made with the identified defect during the geometry based acceptance 116 operation. In some examples, a geometry analysis acceptance criterion can include a maximum percent deviation of the actual geometry of the additively manufactured part from the designed part geometry. In some examples, the geometry analysis acceptance criterion can be provided by the customer to the manufacturer.

In some examples, the analysis 134 of the one or more of the process history based acceptance 112, simulation based acceptance 114, or geometry based acceptance 116 can be consolidated into an overall acceptance 118 decision. The overall acceptance 118 decision can result in a decision to release part 136 or to reject part 138. In either result, the quality assurance system process 100 can proceed to the proprietary information filtering 142 operation. In some examples, the overall acceptance 118 decision, overall acceptance method, overall acceptance analysis, overall acceptance criterion, or combinations thereof can be provided by the customer to the manufacturer.

In some examples, the proprietary information filtering 142 operation can include retrieving a non-proprietary process parameter 124, a sensor data 126, a decision to release part 136, a decision to reject part 138, or a combination thereof. In some examples, the proprietary information filtering 142 operation can filter out confidential information, such as, the proprietary process parameter 122 or sensor data 126. The proprietary information filtering 142 operation can include identifying and removing confidential information, such as, the proprietary process parameter 122 or sensor data 126. The proprietary information filtering 142 operation can also include retrieving an identified defect or an analysis from one of the process history based acceptance 112, simulation based acceptance 114, geometry based acceptance 116, or overall acceptance 118. The purpose of the proprietary information filtering 142 operation can be to remove any confidential information in the form of a proprietary process parameter 122 or sensor data 126 from the quality assurance report 140. In some examples, the output of the proprietary information filtering 142 operation can be a filtered data 144. In some examples, the filtered data can include the identified defect, without non-proprietary process parameter or confidential information (e.g., scan vector, sensor data, etc.).

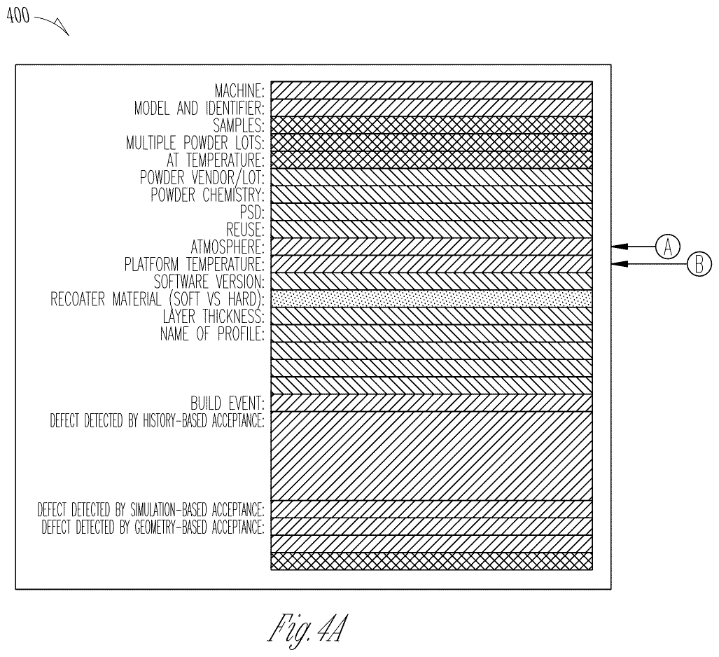

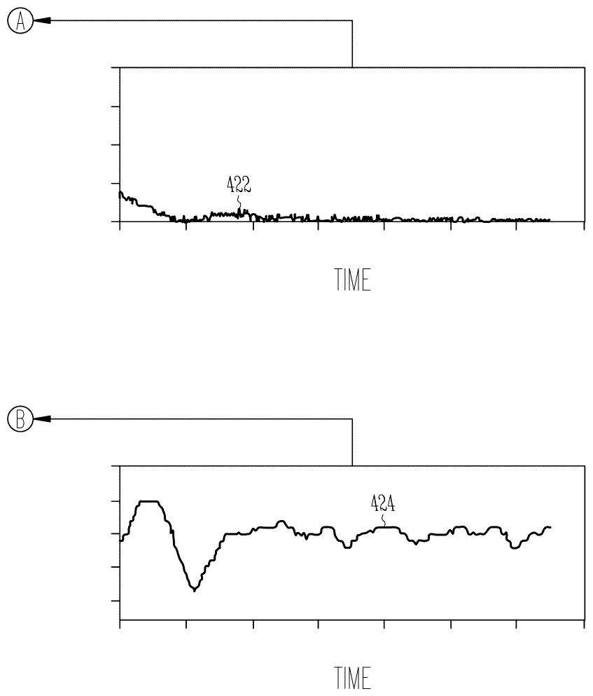

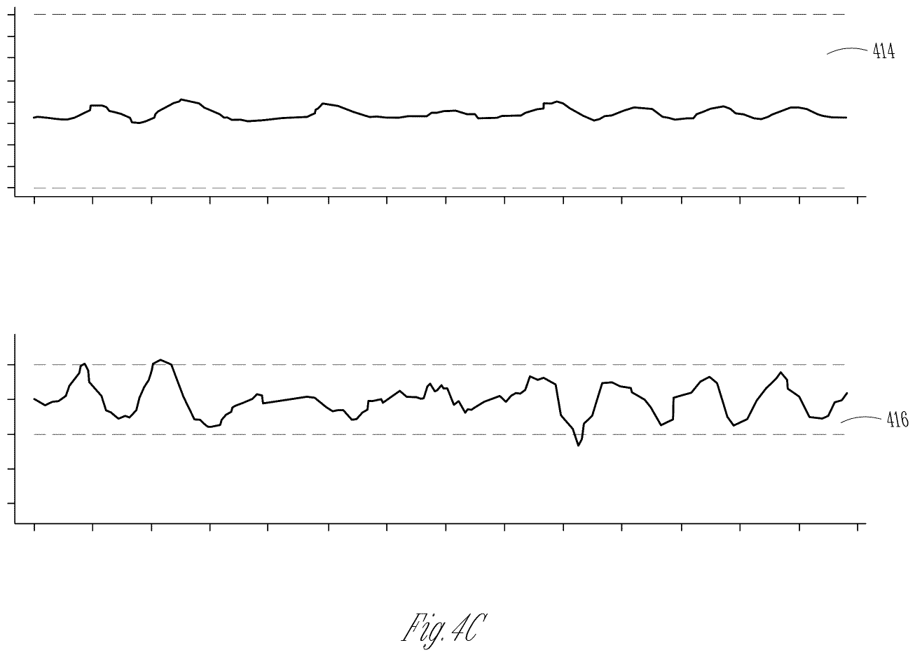

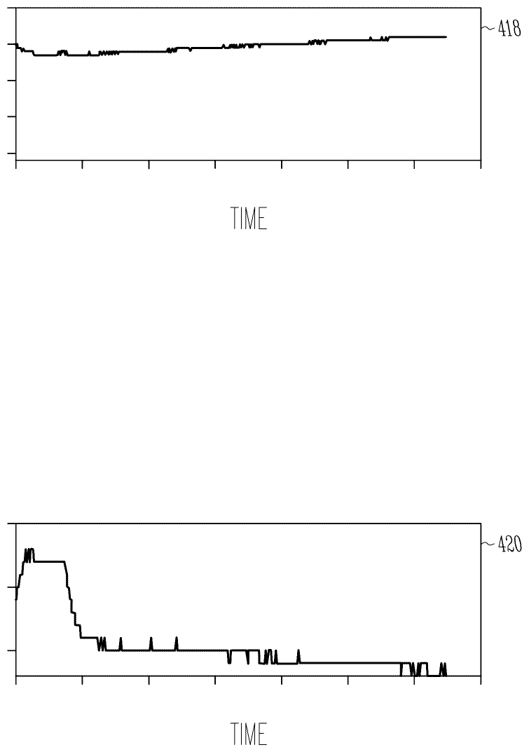

The filtered data 144 can be an input to the generate quality assurance report 120 operation. The output of the generate quality assurance report 120 operation is a quality assurance report 140 that does not contain a proprietary process parameter 122 or other forms of confidential information. In some examples, the quality assurance report 140 can include a description of the defect, a location of the defect, or a combination thereof. Details of a quality assurance report 140 are provided further in the discussion of FIG. 4.

In some examples, the additively manufactured part can be delivered when the additively manufactured part passes a part acceptance criterion. The passing of a part acceptance criterion can include passing a part acceptance criterion of the process history based acceptance 112, the simulation based acceptance 114, the geometry based acceptance 116, the overall acceptance 118, or a combination thereof. The passing of the part acceptance criterion can include passing with no defects in the additively manufactured part, or passing with a defect that does not affect the end application of the part. As used herein, the term delivering can mean for example, shipping of the additively manufactured part to the customer, sending the additively manufactured part out of the factory, transferring the additively manufactured part to a designated pickup location for customer retrieval, releasing the additively manufactured part to a third party logistics provider for further distribution, moving the additively manufactured part from a production area to a finished goods inventory or warehouse, handing over the additively manufactured part to the customer's authorized representative at the manufacturing facility, placing the additively manufactured part into a designated outbound shipment area for processing, releasing the additively manufactured part to the quality control department for final inspection before customer delivery, transferring custody of the additively manufactured part to the customer's preferred carrier or freight forwarder, or the like.

In some examples, the additively manufactured part can be scrapped when the additively manufactured part fails to meet a part acceptance criterion. The failure to meet a part acceptance criterion can include failing to meet a part acceptance criterion of the process history based acceptance 112, the simulation based acceptance 114, the geometry based acceptance 116, the overall acceptance 118, or a combination thereof. As used herein, the term scrapped can mean, for example, discarded, disposed, destroyed, rejected, or not delivered to the customer. For example, upon rejection of the part in operation 138, the quality assurance system process 100 can result in the additively manufactured part being disposed of and not delivered to the customer. The disposal or scrapping can include destruction of the additively manufactured part or recycling of the additively manufactured part to recover raw materials.

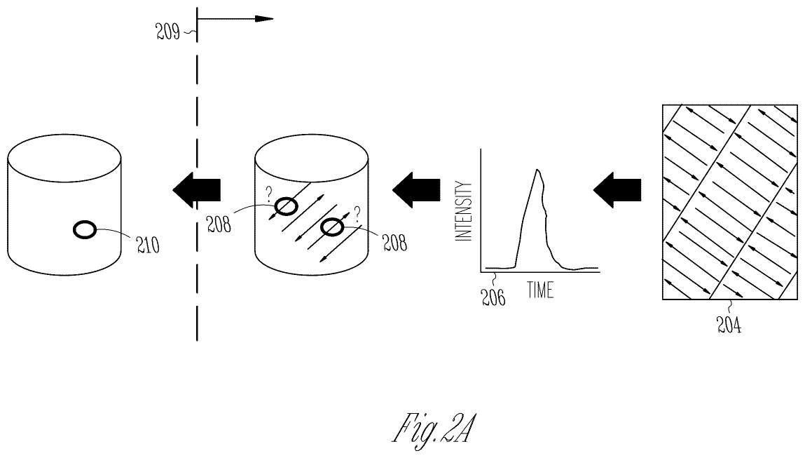

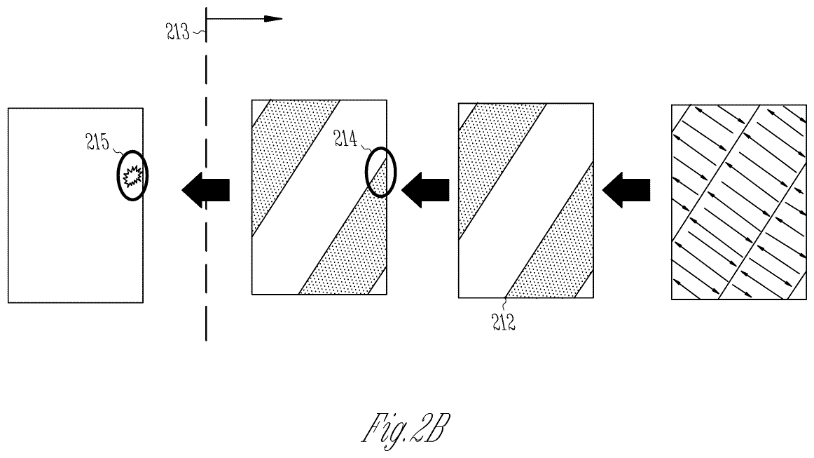

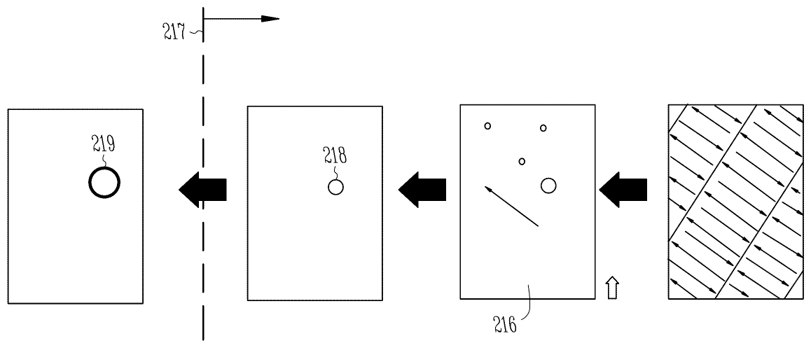

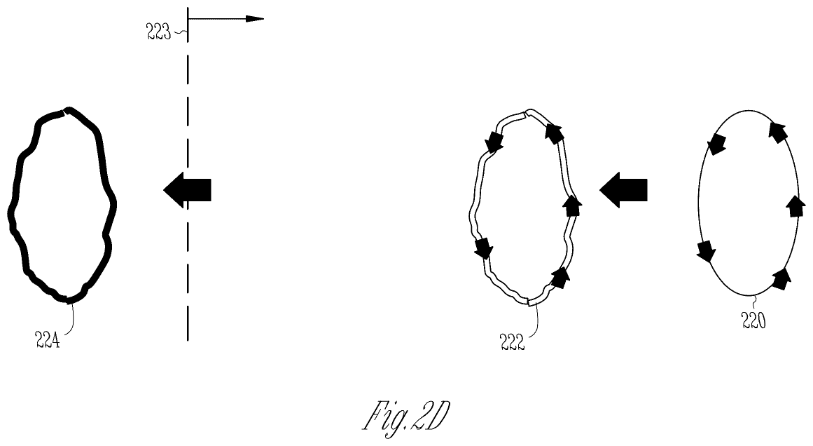

FIG. 2A illustrates, by way of example, a diagram of an embodiment of defect identification by an acoustic signal of the quality assurance system of FIG. 1. In some examples, a scan vector parameter 204 can be considered a proprietary process parameter 122 by the manufacturer. In some examples, the scan vector parameter 204 can include a scan pattern, a scan speed, a hatch spacing, a scan angle, a layer rotation, an infill strategy, a scan overlap amount, a beam focus setting, or a scan order. The scan vector parameter 204 can impact a part property by influencing the microstructure, density, residual stress, or overall mechanical performance of the additively manufactured part. For example, scan speed and hatch spacing can affect the part's density and surface roughness, while scan pattern and layer rotation can influence the anisotropy of mechanical properties. A manufacturer may want to keep the scan vector parameter 204 as a proprietary process parameter 122 as the means to achieve required mechanical properties and quality of the additively manufactured part can be what differentiates the manufacturer from the manufacturer's competitor.

In some examples, sensor data 126 from a sensor can be used to identify a defect. For example, time-series acoustic data 206 can be used in conjunction with a scan strategy that includes a scan vector parameter 204. In an example, an acoustic sensor can be used to identify or isolate a period of high intensity which can be indicative of a defect. The acoustic data 206 can be correlated with the scan vector parameter 204 to determine the location on the additively manufactured part where high acoustic intensity is observed. By analyzing the relationship between the acoustic data 206 and the corresponding scan vector parameter 204, it becomes possible to pinpoint an area of potential concern or anomaly in the additive manufacturing process. For example, the acoustic sensor can detect a high intensity acoustic signal at time T. The quality assurance system process 100 can correlate the location of the part being processed at time T with the scan strategy to locate a location of the anomaly. In some examples, the anomaly can be a potential crack generation site 208 that can be identified as a defect 210.

After the defect has been identified 210, the location of the identified defect 210 can be communicated to the customer as outlined in the quality assurance system process 100 of FIG. 1. In some examples, the location 210 of the defect would be all that is communicated to the customer, i.e. neither the scan vector parameter 204 nor the sensor data 206 leading to generation and identification of the defect, respectively, would be communicated to the customer owing to the proprietary information they implicitly contain. The confidential information that can include the proprietary process parameter and the sensor data can be kept within the proprietary zone 209. In some examples, the information disclosed to the customer can include a type of identified defect 210, an impact of the defect on part performance, a number of defects, the defect size, or a combination thereof. In the disclosure to the customer, no proprietary process parameter will be disclosed (e.g., scan vector parameter 204), and confidential information will be filtered out when a quality assurance report is communicated to the customer. In other examples, the acoustic data 206 or the potential crack generation site 208 can be disclosed, depending on the manufacturer's preference.

FIG. 2B illustrates, by way of example, a diagram of an embodiment of defect identification by a temperature map of the quality assurance system of FIG. 1. In some examples, temperature data collected from a temperature sensor (e.g., an infrared sensor, or a thermal camera) can be used to identify a defect. For example, data collected from a temperature sensor can be used to compile a temperature map 212 of the additively manufactured part during the manufacturing process. In an example, the temperature map 212 can identify an anomalous temperature zone 214 which can be indicative of a defect 215. An anomalous temperature zone 214 can be detrimental to an additively manufactured part for several reasons. For example, a temperature irregularity can lead to inconsistent material properties throughout the part, potentially causing a localized area of weakness or residual stress. An uneven cooling rate resulting from the temperature irregularity can induce microstructure variations, affecting the part's overall mechanical performance and durability.

In some examples, extreme temperature fluctuations can cause thermal distortion, leading to a dimensional inaccuracy and warping of the part. The temperature fluctuation can also impact the formation of a defect such as lack of fusion, keyhole porosity, or balling phenomena. An anomalous temperature zone can compromise the consistency and predictability of the manufacturing process. The lack of consistency or predictability can lead to an increased rejection rate, the need for additional post-processing, potential in-service failures of the additively manufactured part, or a combination thereof.

After the defect has been identified 215, the location of the identified defect 215 can be communicated to the customer as outlined in the quality assurance system process 100 of FIG. 1. The confidential information that can include the proprietary process parameter and the sensor data can be kept within the proprietary zone 213. In some examples, the information disclosed to the customer can also include a type of identified defect 215, an impact of the defect on part performance, a number of defects, a defect size, or a combination thereof. In some examples, the temperature map 212 or the anomalous temperature zone 214 can be disclosed, or the temperature map 212 or the anomalous temperature zone 214 can be kept confidential, depending on the manufacturer's preference.

FIG. 2C illustrates, by way of example, a diagram of an embodiment of defect identification by a visual identification method of the quality assurance system of FIG. 1. In some examples, visual data collected from a camera (e.g., a near-infrared camera, a short-wave camera, a visible light camera, and a long-wave infrared camera) can be utilized to identify a defect in an additively manufactured part. In some examples, a camera can be used to detect a spatter 218 on the additively manufactured part as part of a spatter pattern 216. Spatter 218 on an additively manufactured part can be considered undesirable due to the negative impact on part quality and performance. For example, a spatter artifact 218 can compromise surface quality by creating roughness or an irregularity that can potentially cause deviation from the intended design specification. The spatter defect 219 can lead to additional finishing steps such as polishing or grinding to the manufacturing process. An additional finishing step can add cost and time to the production.

In some examples, a spatter 218 may lead to the formation of a lack-of-fusion void or pore which can compromise the part's density and mechanical properties. A spatter can also introduce impurities or oxides into the part, altering the part's material composition and potentially affecting the part's performance in the intended application. The spatter 218 can lead to the introduction of a weak point that initiates crack propagation or concentrates residual stresses.

After the defect has been identified 219, the location of the identified defect 219 can be communicated to the customer as outlined in the quality assurance system process 100 of FIG. 1. The confidential information that can include the proprietary process parameter and the sensor data can be kept within the proprietary zone 217. In some examples, the information disclosed to the customer can also include a type of identified defect 219, a potential for crack generation, an impact of the defect on part performance, a criticality of the defect, a number of defects, a defect size, or a combination thereof. In some examples, the spatter pattern 216 or the spatter 218 can be disclosed, or the spatter pattern 216 or the spatter 218 can be kept confidential, depending on the manufacturer's preference.

FIG. 2D illustrates, by way of example, a diagram of an embodiment of determination of as-built contour by tracking melt pool geometry around the exterior of a specified geometry, with comparison to the nominal geometry, of the quality assurance system process of FIG. 1. In some examples, the part's contour boundary data can used to identify geometric non-conformance in an additively manufactured part. The melt pool data can be in a variety of different forms, such as, thermal imaging data, an optical reflectivity measurement, spectral emissions data, high-speed camera imagery, laser reflection intensity, acoustic emission data, visible light camera imagery, or electron beam current measurements. In some examples, the melt pool data can be used to determine the part geometry 222 using one or more sensors. The part geometry 222 can then be used to determine the actual geometry 224 of the part after the additive manufacturing process. In some examples, the quality assurance system process 100 can compare the actual geometry 224 of the part or the part geometry in melt pool 222 with the specified part geometry 220 based on the input design. A deviation from the specified part geometry 220 can be highlighted and identified as a potential defect for further analysis. In some examples, the deviation from the specified part geometry 220 can be used as a part acceptance criterion. In some examples, the actual geometry 224 of the part can be measured using a camera for each individual layer and compared with the specified part geometry 220 based on the input design.

In some examples, a deviation of the actual geometry 224 or the part geometry in melt pool 222 from the specified part geometry 220 can lead to a defect due to a variety of reasons. When the melt pool shape and size deviate from the intended design, it can result in a dimensional inaccuracy, causing a part to fall outside a specified tolerance. The dimensional inaccuracy can affect the part's fit, function, and overall quality. In some examples, an inconsistent melt pool geometry can lead to a non-uniform cooling rate and an uneven solidification pattern throughout the part. The non-uniform cooling rate can create inconsistent microstructures, resulting in a localized difference in mechanical properties. The localized difference in mechanical properties can affect the additively manufactured part's strength, ductility, or hardness. Uneven heating and cooling caused by a melt pool geometry deviation can also introduce residual stresses in the part. The residual stresses can manifest as warping, cracking, or deformation during or after the build process. Additionally, an irregular melt pool geometry can result in a surface defect, such as, roughness or ripples. The surface defect can potentially require additional post-processing, or the surface defect can impact the part's performance.

After the defect has been identified, the location of the identified defect can be communicated to the customer as outlined in the quality assurance system process 100 of FIG. 1. The confidential information that can include the proprietary process parameter and the sensor data can be kept within the proprietary zone 223. In some examples, the information disclosed to the customer can also include a type of identified defect, a potential for crack generation, an impact of the defect on part performance, a number of defects, a defect size, or a combination thereof. In some examples, the part geometry in melt pool 222 can be disclosed, or the part geometry in melt pool 222 can be kept confidential, depending on the manufacturer's preference.

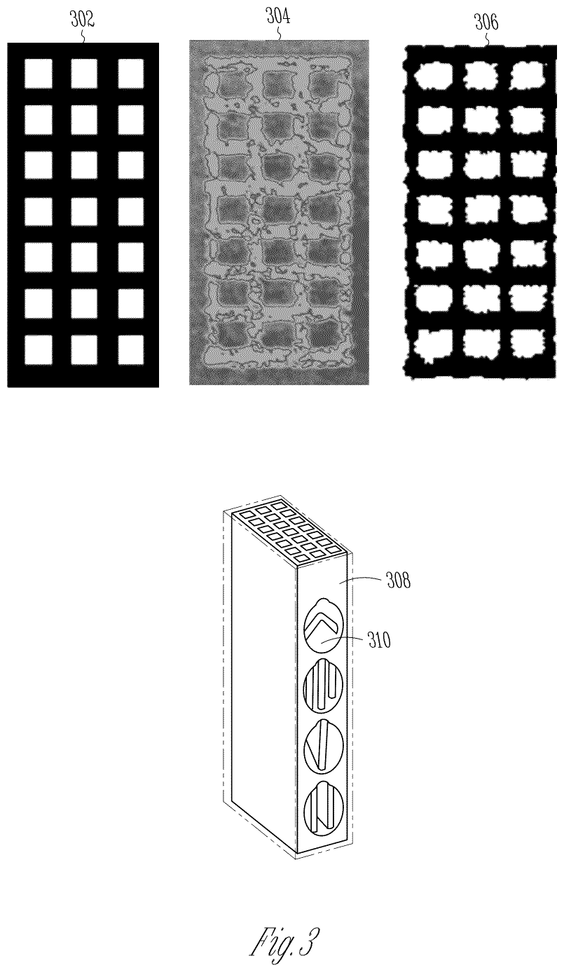

FIG. 3 illustrates, by way of example, a diagram of an embodiment of defect identification by stacking multiple 2D images into a 3D reconstruction, of the quality assurance system of FIG. 1. In some examples, visual layer images can be used to determine the part geometry in the image 304 using one or more methods described in FIG. 2D. In some examples, the part geometry in image 304 can be determined for each individual layer of the additively manufactured part. The part geometry 304 can be indicative of the actual geometry 306 of the additively manufactured part and compared against the nominal part geometry 302. In some examples, each individual layer of the part geometry in 304 or the actual geometry 306 of the additively manufactured part can be stacked 308 to show a 3D representation of the additively manufactured part. From the stacked 2D images 308, a defect 310 can be identified in the reconstructed model of the additively manufactured part.

After the defect has been identified, the location of the identified defect 310 or the stacked 2D images 308 can be communicated to the customer as outlined in the quality assurance system process 100. In some examples, the information disclosed to the customer can also include a type of identified defect 310, a potential for crack generation, an impact of the defect on part performance, a number of defects, the stacked 2D images 308, or a combination thereof.

FIG. 4A-4D illustrate, by way of examples, embodiments of a quality assurance report. In same examples, the quality assurance report 400 can include lot information, including a non-proprietary process condition, an in-line time series process data, an identified defect, a defect size, a defect description, a defect location, an acceptance recommendation, an analysis description, a sensor data, a decision to reject part, a decision to release part, or a combination thereof. However, the quality assurance report 400 will not include a proprietary process parameter.

In some examples, the lot information can include a date of manufacture of the additively manufactured part, a lot number of the additively manufactured part, a lot number of a raw material used in the manufacture of the additively manufactured part (e.g., powder, or additives), a batch number of the additively manufactured part, or a combination thereof.

In some examples, the non-proprietary process condition can include a chamber oxygen concentration, a build plate temperature, a process chamber temperature 418, a turbine pressure 414, a turbine pressure ramp rate 416, or a combination thereof.

In some examples, an in-line time series process data can include a process chamber oxygen concentration 422, a building platform temperature 424, a process chamber temperature 418, a turbine pressure 414, a turbine pressure ramp rate 416, an exposure unit temperature 420, or a combination thereof. The in-line process data can be collected as a continuous measurement of a process parameters, tracking a value or level over time throughout the additive manufacturing operation.

In some examples, the acceptance recommendation can include accepting the additively manufactured part with no defects, accepting the additively manufactured part with the defect, or rejecting the additively manufactured part with the defect. In some examples, the acceptance recommendation can be in the form of a “Go” or “No-Go” for a part to be incorporated into the assembled build.

In some examples, the additively manufactured part can be delivered when the additively manufactured part passes a part acceptance criterion. As used herein, the term delivering can mean, for example, shipping of the additively manufactured part to the customer, sending the additively manufactured part out of the factory, transferring the additively manufactured part to a designated pickup location for customer retrieval, releasing the additively manufactured part to a third party logistics provider for further distribution, moving the additively manufactured part from a production area to a finished goods inventory or warehouse, handing over the additively manufactured part to the customer's authorized representative at the manufacturing facility, placing the additively manufactured part into a designated outbound shipment area for processing, releasing the additively manufactured part to the quality control department for final inspection before customer delivery, transferring custody of the additively manufactured part to the customer's preferred carrier or freight forwarder, or the like.

In some examples, the additively manufactured part can be scrapped when the additively manufactured part fails to meet a part acceptance criterion. As used herein, the term scrapped can mean, for example, discarded, disposed, destroyed, rejected, or not delivered to the customer. In some examples, the part acceptance criterion can be based on the process history acceptance criterion, the simulation analysis acceptance criterion, the geometry analysis acceptance criterion, or a combination thereof.

In some examples, the analysis description can include a description of how the acceptance recommendation can be reached. The analysis description can include highlighting the presence of the identified defect, the reason the acceptance recommendation 410 was determined, or a combination thereof. The analysis description can also include the outcome of the process history based acceptance, simulation based acceptance, or geometry based acceptance. In this instance, information regarding potential defects, including their location and classification could be communicated without disclosing the proprietary or confidential information from which these details were derived.

In some examples, the quality assurance report 400 can include a 3D model of the part for the customer to input into a modeling software for part analysis, performance analysis, or functional acceptance. The functional acceptance can include input of the 3D model of the part into a FEA or CFD program. Examples of file formats can include, STL, OBJ, STEP, IGES, AMF, 3MF, VRML/X3C, or CAD native formats.

In some examples, the quality assurance report 400 can present the information described above in textual representations, graphical representations, or a combination thereof to enhance data presentation. In some examples, a graphical element can be incorporated into the quality assurance report 400 by integrating an output from an automated graphical or image generation program or software. These programs can include data visualization tools used for creating interactive charts and graphs, diagramming software for generating flowcharts or network diagrams, advanced generative artificial intelligence (AI) systems for producing custom illustrations or infographics, or a combination thereof.

In some examples, the level of data sensitivity for disclosure can be determined by the customer, the supplier, or both. The level of data sensitivity can be defined as what constitutes a non-proprietary process condition and a proprietary process parameter for disclosure to the customer. In some examples, the customer can determine the type and format of the non-proprietary process parameter or identified defect to be received.

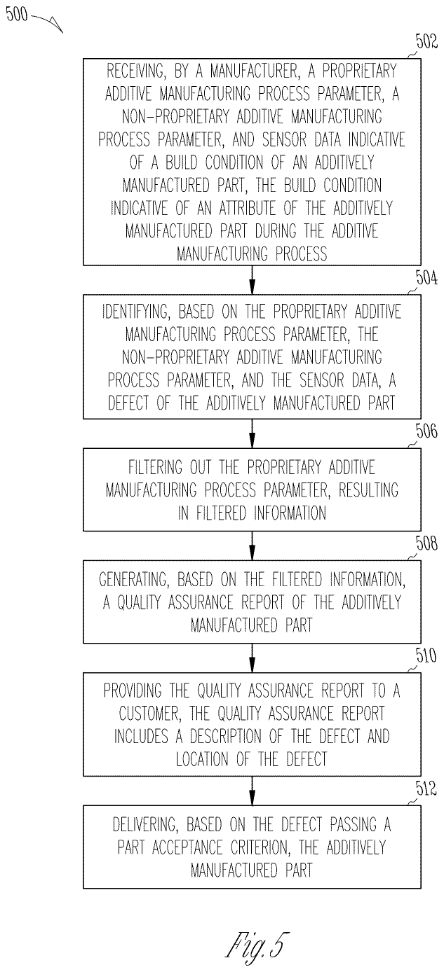

FIG. 5 illustrates by way of example, a flow diagram of an embodiment of a method for quality assurance of an additive manufacturing process by a quality assurance system process 100. The method 500 can be implemented for quality assurance of additive manufactured components.

The method 500, as illustrated includes an operation 502 to receive, by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process; to identify, based on the proprietary additive manufacturing process parameter, the non-proprietary additive manufacturing process parameter, and the sensor data, a defect of the additively manufactured part, at operation 504; to filter out the proprietary additive manufacturing process parameter, resulting in filtered information, at operation 506; to generate, based on the filtered information, a quality assurance report of the additively manufactured part, at operation 508; to provide the quality assurance report to a customer, the quality assurance report includes a description of the defect and location of the defect, at operation 510; and to deliver, based on the defect passing a part acceptance criterion, the additively manufactured part, at operation 512.

The operation 502 can further include, wherein the proprietary additive manufacturing process parameter includes at least one of a scan vector parameter, a layer thickness, an energy source parameter, a powder bed parameter, a heat treatment parameter, or a post-processing parameter.

The operation 502 can further include, wherein the energy source parameter includes at least one of a laser power, a laser speed, a spot size, or a pulse duration.

The operation 502 can further include, wherein the non-proprietary additive manufacturing process parameter includes at least one of a chamber oxygen concentration, heat treatment profile, a build plate temperature, a process chamber temperature, a turbine pressure, or a turbine pressure ramp rate.

The operation 502 can further include, wherein the sensor data includes at least one of a photodiode measurement, an acoustic measurement, a transducer measurement, a temperature measurement, a near infrared (IR) camera data, a short-wave IR camera data, a long-wave IR data, or a visible camera data.

The operation 504 can further include, wherein to identify a defect includes to identify at least one of a temperature-induced defect, a spatter-induced defect, a swelling defect, a delamination defect, a geometric fidelity defect, an anisotropic defect, or an inclusion defect.

The operation 504 can further include, wherein to identify the defect includes using at least one of a numerical method, a machine learning trained model, or a physics-based model.

The operation 504 can further include, wherein to identify the defect includes using at least one of a numerical method, a machine learning trained model, or a physics-based model.

The operation 504 can further include, wherein the machine learning trained model includes at least one of a computer vision system, or a temperature-based system to predict metal grain and metal microstructure.

The operation 504 can further include, wherein the physics-based model includes at least one of a finite element analysis (FEA) model, a computational fluid dynamics (CFD) model, fatigue analysis, thermal analysis, or structural analysis.

The operation 506 can further include, wherein to filter out further includes to filter out sensor data.

The operation 506 can further include, wherein to filter out includes to filter and remove the proprietary additive manufacturing process parameter.

The operation 510 can further include, wherein the quality assurance report further includes at least one of a time series of the non-proprietary additive manufacturing process parameter, the non-proprietary additive manufacturing process parameter, a model of the additively manufactured part, or an acceptance recommendation.

The operation 512 can further include, wherein the part acceptance criterion includes at least one of a process history acceptance criterion, a simulation analysis acceptance criterion, or a geometry analysis acceptance criterion.

The operation 500 can further include, to scrap, based on the defect failing the part acceptance criterion, the additively manufactured part.

FIG. 6 illustrates a machine learning engine for training a program for quality assurance of an additive manufacturing process in accordance with at least one example of this disclosure. The machine learning engine may be deployed to execute at a mobile device (e.g., a cell phone, a tablet, etc.), a computer (e.g., a desktop, a laptop, etc.), or an edge device (e.g., a smart sensor, an IoT device, a network router, etc.). FIG. 6 shows an example machine learning engine 600 according to some examples of the present disclosure.

Machine learning engine 600 uses a training engine 602 and a prediction engine 604. Training engine 602 uses input data 606, for example after undergoing preprocessing component 608, to determine one or more features 610. The one or more features 610 can be used to generate an initial model 612, which can be updated iteratively or with future labeled or unlabeled data (e.g., during reinforcement learning), for example to improve the performance of the prediction engine 604 or the initial model 612. An improved model can be redeployed for use.

The input data 606 can include data sets, such as, proprietary process parameters 122, non-proprietary process parameters 124, sensor data 126, types of defects, or effects of defects in an assembled build.

In the prediction engine 604, current data 614 (e.g., proprietary process parameters 122, non-proprietary process parameters 124, or sensor data 126) can be input to preprocessing component 616. In some examples, preprocessing components 616 and preprocessing component 608 are the same. The prediction engine 604 produces feature vector 618 from the preprocessed current data, which is input into the model 620 to generate one or more criteria weightings 622. The criteria weightings 622 can be used to output a prediction, as discussed further below.

The training engine 602 can operate in an offline manner to train the model 620 (e.g., on a server). The prediction engine 604 can be designed to operate in an online manner (e.g., in real-time, at a mobile device, edge device, etc.). In some examples, the model 620 can be periodically updated via additional training (e.g., via updated input data 606 or based on labeled or unlabeled data output in the criteria weightings 622) or based on identified future data, such as by using reinforcement learning to personalize a general model (e.g., the initial model 612) to a particular user.

Labels for the input data 606 can include no defects, acceptable defects, critical defects, unacceptable defects, part acceptance, or part rejection.

The initial model 612 can be updated using further input data 606 until a satisfactory model 620 is generated. The model 620 generation can be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 602 can be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 602. In an example embodiment, a regression model is used and the model 620 is a vector of coefficients corresponding to a learned importance for each of the features in the vector of features 610, 618. A reinforcement learning model can use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 620 may output a prediction, such as, the presence of no defects, the presence of an acceptable defect, the presence of a critical defect, the presence of an unacceptable defect, or the implications of a defect.

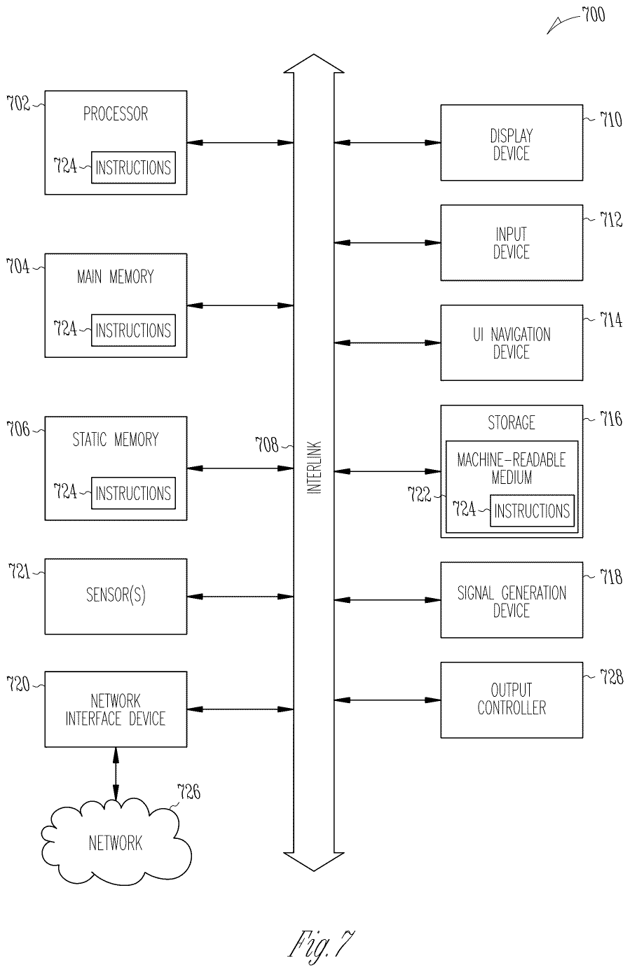

FIG. 7 illustrates generally an example of a block diagram of a machine upon which any one or more of the techniques discussed herein can perform in accordance with at least one example of this disclosure. A variety of operations, methodologies, or processes described herein may be executed, implemented, or performed by one or more of the components of the computer system 700, for example, the quality assurance system 100, method 500, or machine learning engine 600. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

This example machine can operate some or all of quality assurance system discussed herein. In some examples, the quality assurance system can operate on the example machine 700. In other examples, the example machine 700 is merely one of many such machines used to operate the quality assurance system. In alternative embodiments, the example machine 700 can operate as a standalone device or can be connected (e.g., networked) to other machines. In a networked deployment, the example machine 700 can operate in the capacity of a server machine, a client machine, or both in server-client network environments. In an example, the example machine 700 can act as a peer machine in peer-to-peer (P2P) (or other distributed) network environment. The example machine 700 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 700 can include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The example machine 700 can further include a display device 710, an alphanumeric input device 712 (e.g., a keyboard), and a user interface UI navigation device 714 (e.g., a mouse). In an example, the display device 710, input device 712 and UI navigation device 714 can be a touch screen display. The 700 can additionally include a storage device 716 (e.g., drive unit), a signal generation device 718 (e.g., a speaker), a network interface device 720, and one or more sensors 721, such as a global positioning system (GPS) sensor, compass, accelerometer, or other sensor. The 700 can include an output controller 728, such as a serial (e.g., Universal Serial Bus (USB), parallel, or other wired or wireless (e.g., infrared (IR), near field communication (NFC), etc.) connection to communicate or control one or more peripheral devices (e.g., a printer, card reader, etc.).

The storage device 716 can include a machine readable machine-readable medium 722 on which is stored one or more sets of data structures or instructions 724 (e.g., software) embodying or utilized by any one or more of the techniques or functions described herein. The instructions 724 can also reside, completely or at least partially, within the main memory 704, within static memory 706, or within the hardware processor 702 during execution thereof by the 700. In an example, one or any combination of the hardware processor 702, the main memory 704, the static memory 706, or the storage device 716 can constitute machine readable media.

While the machine-readable medium 722 is illustrated as a single medium, the term “machine readable medium” can include a single medium or multiple media (e.g., a centralized or distributed database, or associated caches and servers) configured to store the one or more instructions 724. The term “machine readable medium” can include any medium that is capable of storing, encoding, or carrying instructions for execution by the 700 and that cause the 700 to perform any one or more of the techniques of the present disclosure, or that is capable of storing, encoding or carrying data structures used by or associated with such instructions. Non-limiting machine-readable medium examples can include solid-state memories, and optical and magnetic media.

The instructions 724 can further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 702.11 family of standards known as Wi-Fi®, IEEE 602.16 family of standards known as WiMax®), IEEE 702.15.4 family of standards, peer-to-peer (P2P) networks, among others. In an example, the network interface device 720 can include one or more physical jacks (e.g., Ethernet, coaxial, or phone jacks) or one or more antennas to connect to the communications network 726. In an example, the network interface device 720 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the 700, and includes digital or analog communications signals or other intangible medium to facilitate communication of such software.

### EXAMPLES AND ADDITIONAL NOTES

Example 1 is a method for quality assurance of an additive manufacturing process, the method comprising: receiving, by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process; identifying, based on the proprietary additive manufacturing process parameter, the non-proprietary additive manufacturing process parameter, and the sensor data, a defect of the additively manufactured part; filtering out the proprietary additive manufacturing process parameter, resulting in filtered information; generating, based on the filtered information, a quality assurance report of the additively manufactured part; providing the quality assurance report to a customer, the quality assurance report includes, a description of the defect and location of the defect; and delivering, based on the defect passing a part acceptance criterion, the additively manufactured part.
In Example 2, the subject matter of Example 1 includes, wherein the proprietary additive manufacturing process parameter includes at least one of a scan vector parameter, a layer thickness, an energy source parameter, a powder bed parameter, a heat treatment parameter, or a post-processing parameter.
In Example 3, the subject matter of Example 2 includes, wherein the energy source parameter includes at least one of a laser power, a laser speed, a spot size, or a pulse duration.
In Example 4, the subject matter of Examples 1-3 includes, wherein the non-proprietary additive manufacturing process parameter includes at least one of a chamber oxygen concentration, heat treatment profile, a build plate temperature, a process chamber temperature, a turbine pressure, or a turbine pressure ramp rate.
In Example 5, the subject matter of Examples 1-4 includes, wherein the sensor data includes at least one of a photodiode measurement, an acoustic measurement, a transducer measurement, a temperature measurement, a near infrared (IR) camera data, a short-wave IR camera data, a long-wave IR data, or a visible camera data.
In Example 6, the subject matter of Examples 1-5 includes, wherein identifying a defect includes identifying at least one of a temperature-induced defect, a spatter-induced defect, a swelling defect, a delamination defect, a geometric fidelity defect, an anisotropic defect, or an inclusion defect.
In Example 7, the subject matter of Examples 1-6 includes, wherein identifying the defect includes using at least one of a numerical method, a machine learning trained model, or a physics-based model.
In Example 8, the subject matter of Example 7 includes, wherein the machine learning trained model includes at least one of a computer vision system, or a temperature-based system to predict metal grain and metal microstructure.
In Example 9, the subject matter of Examples 7-8 includes, wherein the physics-based model includes at least one of a finite element analysis (FEA) model, a computational fluid dynamics (CFD) model, fatigue analysis, thermal analysis, or structural analysis.
In Example 10, the subject matter of Examples 1-9 includes, wherein filtering out further includes filtering out sensor data.
In Example 11, the subject matter of Examples 1-10 includes, wherein filtering out includes identifying and removing the proprietary additive manufacturing process parameter.
In Example 12, the subject matter of Examples 1-11 includes, wherein the quality assurance report further includes at least one of a time series of the non-proprietary additive manufacturing process parameter, the non-proprietary additive manufacturing process parameter, a model of the additively manufactured part, or an acceptance recommendation.
In Example 13, the subject matter of Examples 1-12 includes, wherein the part acceptance criterion includes at least one of a process history acceptance criterion, a simulation analysis acceptance criterion, or a geometry analysis acceptance criterion.
In Example 14, the subject matter of Examples 1-13 includes, scrapping, based on the defect failing the part acceptance criterion, the additively manufactured part.
Example 15 is a non-transitory machine-readable medium comprising instructions that when executed by a processor executes a process comprising: receiving, by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process; identifying, based on the proprietary additive manufacturing process parameter, the non-proprietary additive manufacturing process parameter, and the sensor data, a defect of the additively manufactured part; filtering out the proprietary additive manufacturing process parameter, resulting in filtered information; generating, based on the filtered information, a quality assurance report of the additively manufactured part; providing the quality assurance report to a customer, the quality assurance report includes, a description of the defect and location of the defect; and delivering, based on the defect passing a part acceptance criterion, the additively manufactured part.
In Example 16, the subject matter of Example 15 includes, wherein filtering out further includes filtering out sensor data.
In Example 17, the subject matter of Examples 15-16 includes, wherein filtering out includes identifying and removing the proprietary additive manufacturing process parameter.
Example 18 is a system comprising: a computer processor; and a computer memory coupled to the computer processor; wherein the computer processor and the computer memory are operable for: receiving, by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process; identifying, based on the proprietary additive manufacturing process parameter, the non-proprietary additive manufacturing process parameter, and the sensor data, a defect of the additively manufactured part; filtering out the proprietary additive manufacturing process parameter, resulting in filtered information; generating, based on the filtered information, a quality assurance report of the additively manufactured part; providing the quality assurance report to a customer, the quality assurance report includes, a description of the defect and location of the defect; and delivering, based on the defect passing a part acceptance criterion, the additively manufactured part.
In Example 19, the subject matter of Example 18 includes, wherein filtering out further includes filtering out sensor data.
In Example 20, the subject matter of Examples 18-19 includes, wherein filtering out includes identifying and removing the proprietary additive manufacturing process parameter.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for quality assurance of an additive manufacturing process, the method comprising:
receiving, by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process;
identifying, based on the proprietary additive manufacturing process parameter, the non-proprietary additive manufacturing process parameter, and the sensor data, a defect of the additively manufactured part;
filtering out the proprietary additive manufacturing process parameter, resulting in filtered information;
generating, based on the filtered information, a quality assurance report of the additively manufactured part;
providing the quality assurance report to a customer, the quality assurance report includes a description of the defect and location of the defect; and
delivering, based on the defect passing a part acceptance criterion, the additively manufactured part.

2. The method of claim 1, wherein the proprietary additive manufacturing process parameter includes at least one of a scan vector parameter, a layer thickness, an energy source parameter, a powder bed parameter, a heat treatment parameter, or a post-processing parameter.

3. The method of claim 2, wherein the energy source parameter includes at least one of a laser power, a laser speed, a spot size, or a pulse duration.

4. The method of claim 1, wherein the non-proprietary additive manufacturing process parameter includes at least one of a chamber oxygen concentration, heat treatment profile, a build plate temperature, a process chamber temperature, a turbine pressure, or a turbine pressure ramp rate.

5. The method of claim 1, wherein the sensor data includes at least one of a photodiode measurement, an acoustic measurement, a transducer measurement, a temperature measurement, a near infrared (IR) camera data, a short-wave IR camera data, a long-wave IR data, or a visible camera data.

6. The method of claim 1, wherein identifying a defect includes identifying at least one of a temperature-induced defect, a spatter-induced defect, a swelling defect, a delamination defect, a geometric fidelity defect, an anisotropic defect, or an inclusion defect.

7. The method of claim 1, wherein identifying the defect includes using at least one of a numerical method, a machine learning trained model, or a physics-based model.

8. The method of claim 7, wherein the machine learning trained model includes at least one of a computer vision system, or a temperature-based system to predict metal grain and metal microstructure.

9. The method of claim 7, wherein the physics-based model includes at least one of a finite element analysis (FEA) model, a computational fluid dynamics (CFD) model, fatigue analysis, thermal analysis, or structural analysis.

10. The method of claim 1, wherein filtering out further includes filtering out sensor data.

11. The method of claim 1, wherein filtering out includes identifying and removing the proprietary additive manufacturing process parameter.

12. The method of claim 1, wherein the quality assurance report further includes at least one of a time series of the non-proprietary additive manufacturing process parameter, the non-proprietary additive manufacturing process parameter, a model of the additively manufactured part, or an acceptance recommendation.

13. The method of claim 1, wherein the part acceptance criterion includes at least one of a process history acceptance criterion, a simulation analysis acceptance criterion, or a geometry analysis acceptance criterion.

14. The method of claim 1, further comprising scrapping, based on the defect failing the part acceptance criterion, the additively manufactured part.

15. A non-transitory machine-readable medium comprising instructions that when executed by a processor executes a process comprising:
receiving, by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process;
identifying, based on the proprietary additive manufacturing process parameter, the non-proprietary additive manufacturing process parameter, and the sensor data, a defect of the additively manufactured part;
filtering out the proprietary additive manufacturing process parameter, resulting in filtered information;
generating, based on the filtered information, a quality assurance report of the additively manufactured part;
providing the quality assurance report to a customer, the quality assurance report includes a description of the defect and location of the defect; and
delivering, based on the defect passing a part acceptance criterion, the additively manufactured part.

16. The non-transitory machine-readable medium of claim 15, wherein filtering out further includes filtering out sensor data.

17. The non-transitory machine-readable medium of claim 15, wherein filtering out includes identifying and removing the proprietary additive manufacturing process parameter.

18. A system comprising:
a computer processor; and
a computer memory coupled to the computer processor;
wherein the computer processor and the computer memory are operable for:
receiving, by a manufacturer, a proprietary additive manufacturing process parameter, a non-proprietary additive manufacturing process parameter, and sensor data indicative of a build condition of an additively manufactured part, the build condition indicative of an attribute of the additively manufactured part during the additive manufacturing process;
identifying, based on the proprietary additive manufacturing process parameter, the non-proprietary additive manufacturing process parameter, and the sensor data, a defect of the additively manufactured part;
filtering out the proprietary additive manufacturing process parameter, resulting in filtered information;
generating, based on the filtered information, a quality assurance report of the additively manufactured part;
providing the quality assurance report to a customer, the quality assurance report includes a description of the defect and location of the defect; and
delivering, based on the defect passing a part acceptance criterion, the additively manufactured part.

19. The system of claim 18, wherein filtering out further includes filtering out sensor data.

20. The system of claim 18, wherein filtering out includes identifying and removing the proprietary additive manufacturing process parameter.
